(19) United States
(12) Patent Application Publication
(10) Pub. No.: US 2003/0139959 A1
(43) Pub. Date: Jul. 24, 2003

(54) Mass transit security sector

(76) Inventor: Taleb Sabouni, Irvine, CA (US)

Correspondence Address: FISH & RICHARDSON, PC, 4350 LA JOLLA VILLAGE DRIVE, SUITE 500, SAN DIEGO, CA, 92122, US

(21) Appl. No.: 10/123,698

(22) Filed: Apr. 15, 2002

Related U.S. Application Data
(60) Provisional application No. 60/349,941, filed on Jan. 18, 2002.

(51) Int. Cl. G09B 19/00; G06F 17/60

(52) U.S. Cl. 705/8

(57) ABSTRACT

A mass transit security system is provided. The mass transit security system offers an effective wide spread technique for protecting mass transit vehicles (e.g., airlines, trains, ships, and buses) and passengers against terrorist attacks, especially, when they are detached from secure terminals. A Passenger Security Force is a security sector that includes teams of frequent travelers with cleared security background checks, who receive basic training on how to coordinate a response to an attack on board a mass transit vehicle, and willing to follow required security measures while traveling. The Passengers' Security Force may work in conjunction with a special (PSF) ground control operation room, government security forces.

### CLAIM OF PRIORITY

This application claims priority to U.S. Provisional Patent Application No. 60/349,941 filed on Jan. 18, 2002, which is hereby incorporated by reference in its entirety.

### BACKGROUND

1. Field of the Invention

The invention is generally related to mass transit systems, and in particular, is related to improving security for mass transit systems.

2. Description of Related Art

On Sep. 11, 2001 terrorists hijacked several airplanes in the United States (U.S.) and crashed them into various buildings using these airplanes as weapons of mass destruction. Since these events, governments, travelers, and airlines alike have been alarmed about the safety of mass transit, and, in particular, about airline safety, more than ever.

In response to these terrorist events, increased security measures are being implemented in airplanes and at airports such as enforcing flight deck doors, enhancing passengers and baggage screening, and enhancing security background check systems.

Airports around the U.S. are handling over 600 million passengers every year. Consequently, the tendency to compromise quality of security to cost effectiveness and customer satisfaction during handling mass quantities of travelers will remain a major concern to security. Furthermore, there is no satisfactory solution for identifying and capturing terrorists before they possibly stream with passengers and board mass transit vehicles (e.g., airlines).

The inability to identify terrorists is exacerbated by the fact that most attacks take place when mass transit vehicles are detached from terminals (e.g., when airplanes are airborne), far away from terminal-based security forces. However, until now, there is a shortage of effective inventions in security techniques for protecting mass transit vehicles (e.g., airlines, trains, ships and buses) and passengers against terrorist attacks, when mass transit vehicles are detached from terminals' attached security.

September 11^{th} events proved a new doctrine that “No flight is a low risk security flight,” thus contradicting the earlier strategy behind the federal air marshals program, to be present only on selected high-risk flights. Consequently, the program failed to provide security in the air, where terrorists openly announce their reality. Given the extremely large number of flights per day, it is too expensive and a waste of resources to have sky marshals on every flight.

On Sep. 11, 2001, many lives were lost on the airplanes that were hijacked and crashed into buildings or onto the ground. However, New York City's losses were more severe than the losses of lives and property lost with the four airplanes that crashed, both in death count and in property destroyed. Consequently, the new wave of terror positioned not only airlines and airports, but also cities and civilized cultures, in the efforts of preventing terrorist acts. For this reason, the Federal Aviation Administration (FAA) director, announced on Sep. 28, 2001 a new restricted airspace policy adopted by the Department of Defense (DOD) on Sep. 27, 2001, where “Pilots near or in restricted or prohibited airspace face a force landing, or as last resort, use of deadly force by military aircrafts” (Attachment 1). However, this decision positioned travelers between the “hamrnmer” of the terrorists and the “hard place” of the resolute government of the U.S. that vowed never to bow to terrorists. Passengers are left with little chance of survival and no choice in what will happen to them.

### SUMMARY OF THE INVENTION

The United States of America President George W. Bush, in his State of the Union speech of Jan. 29, 2002, said “Now America is embracing a new ethic and a new creed: ‘Let's Roll,’” referring to passengers' actions on board hijacked United Airlines flight 93 that crashed on rural Pennsylvania on Sep. 11, 2001. President George W. Bush said also in the same speech “And as government works to better secure our homeland, America will continue to depend on the eyes and ears of alert citizens. A few days before Christmas, an airline flight attendant spotted a passenger lighting a match. The crew and passengers quickly subdued the man, who had been trained by al Qaeda and was armed with explosives. The people on that airplane were alert, and as a result likely saved nearly 200 lives,” recognizing that “America will continue to depend on the eyes and ears of alert citizens.”

In accordance with some embodiments of the invention, a mass transit security system is provided. The mass transit security system offers an effective wide-spread technique for protecting mass transit vehicles (e.g., airlines, trains, ships and buses) and passengers against terrorist attacks, especially, when they are detached from secure terminals. In particular, a Passengers Security Force entity (PSF) is developed to coordinate and enhance passengers' reaction to, for example, terrorist attacks, and to create a culture of security-alert travelers. A Passenger Security Force includes teams of frequent travelers with cleared security background checks, who receive basic training on how to coordinate a response to an attack on board a mass transit vehicle, and willing to follow required security measures while traveling. Passengers' Security Force teams may work in conjunction with a special PSF ground control operation room, government security forces, for example, Federal Air Marshals, and mass transit security forces.

The invention is better understood upon consideration of the detailed description below, and the accompanying drawings.

### BRIEF DESCRIPTION OF THE DRAWINGS

FIG. 1 illustrates a block diagram of airline security divided into three sectors, after introducing the passengers' security sector, in accordance with some embodiments of the invention.

FIGS. 2A and 2B illustrate flowcharts of acts demonstrating a process of how a Passenger Security Force may be created, in accordance with some embodiments of the invention.

FIG. 3 illustrates a flowchart of acts demonstrating what is expected of PSF members from the time they reserve a seat on a mass transit vehicle until they earn program points, in accordance with some embodiments of the invention.

FIGS. 4A and 4B illustrate flowcharts of acts demonstrating what is expected of PSF members during non-emergency situations, in accordance with some embodiments of the invention.

FIG. 5 illustrates a flowchart of acts demonstrating what is expected of PSF members during emergency situations, in accordance with some embodiments of the invention.

FIG. 6 illustrates a flowchart of acts demonstrating coordination between the three security sectors: mass transit sector, government sector, and passengers sector, in accordance with some embodiments of the invention.

FIG. 7 illustrates a block diagram of a corporate management structure for a PSF corporation, in accordance with some embodiments of the invention.

FIG. 8 illustrates a table of target minimum PSF members to be recruited in five years in accordance with some embodiments of the invention.

Use of the same reference symbols in different figures indicates similar or identical items.

### DETAILED DESCRIPTION

In accordance with some embodiments of the invention, a mass transit security system is provided. The mass transit security system offers an effective wide spread technique for protecting mass transit vehicles (e.g., airlines, trains, ships, and buses) and passengers against terrorist attacks, especially, when they are detached from secure terminals. In particular, a Passengers Security Force entity (PSF) may coordinate and enhance passengers' reaction to, for example, terrorist attacks, and to create a culture of security alert travelers. A Passenger Security Force includes teams of frequent travelers with cleared security background checks, who receive basic training on how to coordinate a response to an attack on board a mass transit vehicle, and willing to follow required security measures while traveling. Passengers' Security Force teams may work in conjunction with a special PSF ground control operation room, government security forces, for example, Federal Air Marshals, and mass transit security forces.

It is to be understood that any reference to a particular form of mass transit, such as airplanes, serves to illustrate an example of application of the invention to a particular mass transit system and is not intended to limit the invention to that particular mass transit system.

Introducing Passenger Resistance

When calculating terror acts against airlines, terrorists analyze mass transit and government security (e.g., counter terror) measures, and try to avoid these security measures to stream with passengers and board mass transit vehicles. The terrorists know that in mass transit systems, such as airlines with airports around the U.S. are handling over 600 million passengers every year, there is no absolute solution for identifying these terrorists before they announce their dreadful reality on board mass transit vehicles (e.g., airlines).

Moreover, terrorists have the advantage of time, and they may spend years studying routines used to implement security measures. Routines refer to acts that are performed repeatedly in a similar manner. These routines are useful in training individuals to implement security measures. In some ways, however, routines may weaken the security measures. For example, when an individual is performing a routine many times, the individual may not obverse activities as well after many repetitions of the routine.

Terrorists typically take into account various risks, such as the risk of detection of their activities prior to boarding a mass transit vehicle. The last risk terrorists consider, however, is resistance from passengers on board the vehicle. Succeeding in streaming with passengers and boarding a mass transit vehicle is considered mission success for terrorists.

Previously, it was thought that victims of hijackings are most likely to obey abductors, and so terrorists predict passengers will act docile and obey them. Thus, terrorists, and sometimes even governments and mass transit securities, expect passengers to be silent and helpless victims, under the mercy of the terrorists.

The new wave of terrorism that began on Sep. 11, 2001, changed forever these concepts of passengers' reactions.

Passengers on board the hijacked United Airlines flight 93 (that crashed in rural Pennsylvania on Sep. 11, 2001) and passengers on board American Airlines flight 63 (on which an individual with bomb material in his shoe was identified on Dec. 23, 2001) proved that passenger resistance is an important factor in security measures. The passengers on board flight 93 resisted the terrorists. The passengers on board flight 93 put their lives at risk when they decided to attack the terrorists who had commandeered the airplane. While the passengers were unable to preserve their own lives on flight 93, the passengers did prevent the hijackers of the airplane from crashing the airplane into a building or highly populated area. Passengers of flight 93 saved lives on the ground.

Likewise, on flight 63, flight crew and passengers apprehended an individual named Richard Reid, who had bomb material in his shoe, before doing damage to the airplane and/or passengers. When the flight crew and passengers were able to prevent Richard Reid from exploding a bomb on board flight 63, they gave security agencies (e.g., government and mass transit security agencies) a great lead (e.g., the suspect) to pursue in the war against terrorism.

In particular, the events of Sep. 11, 2001 and thereafter introduced passenger resistance as a new resource in resisting terror on mass transit vehicles, and, in particular, on airplanes. Because attacks may take place far from mass transit centers (e.g., airports, train stations, ship ports, or bus stations) and away from other areas that are covered by government or mass transit security forces (e.g., up in the air), passengers may be the first line of resistance, rather than government or mass transit security forces.

The U.S. Government New Restricted Airspace and Passengers Resistance

When ground losses proved to be more severe than the loss of the airplanes lost in the terror acts against airlines, the events of Sep. 11, 2001 paved the way for demanding implementation of complete and comprehensive solutions to the problem of terrorist activities aboard mass transit vehicles (e.g., airplanes, trains, ships, and buses).

As a result, the Federal Aviation Administration (FAA) director, announced on Sep. 28, 2001 a new restricted airspace policy adopted by the Department of Defense (DOD) on Sep. 27, 2001, where “Pilots near or in restricted or prohibited airspace face a force landing, or as last resort, use of deadly force by military aircrafts.” This places passengers on board airplanes in a difficult position.

The passengers are placed between the “hammer” of the terrorists and the “hard place” of the resolute governments that vowed never to bow to terrorists. Passengers are left with little chance of survival and no choice in what will happen to them.

However, the United States of America President, George W. Bush, in his State of the Union speech of Jan. 29, 2002, said “Now America is embracing a new ethic and a new creed: ‘Let's Roll,’” referring to passengers' resistance to terrorism on board of hijacked United Airlines flight 93 that crashed on rural Pennsylvania on Sep. 11, 2001. In addition, he said in the same speech “And as government works to better secure our homeland, America will continue to depend on the eyes and ears of alert citizens. A few days before Christmas, an airline flight attendant spotted a passenger lighting a match. The crew and passengers quickly subdued the man, who had been trained by al Qaeda and was armed with explosives. The people on that airplane were alert, and as a result likely saved nearly 200 lives,” acknowledging in one important speech, two times, the fact that passengers constitute a force that provide security and save lives. Consequently, passengers' resistance to terrorism became part of the State of the Union and is embraced as a new American ethic.

The State of the Union address of January 2002 acknowledges passenger resistance, and the Sep. 27, 2001 decision of DOD, which enforces the new restricted airspace policy, encourages passengers to resist terrorism before the DOD has to make the ultimate last resort decision. Therefore, the DOD cannot claim reaching the “last resort” and use deadly force against civilian airplanes, without demonstrating that passengers were given the chance to resist terrorists. This could be properly achieved by giving passengers the chance to be prepared in advance to utilize their resistance in an organized manner, as explained below.

Nevertheless, the DOD should enforce the new restricted airspace policy for another reason than the threat of terrorists penetrations among passengers, which is the difficulty of having absolute certainty of all crew members and service personnel, such as catering, cleaning and grounds crew, of all commercial flights that exceeds 25,000 daily flights. Therefore, it is important to implement embodiments of the invention described in the following new security technique without any delay

The invention applications recognize that passengers may resist terrorism, and that when the passengers have the chance to be prepared in advance to exploit their resistance in a calculated and organized manner, they will enhance safety when mass transit vehicles are away from terminals attached security (e.g., when airplanes are up in the air). Also, the invention applications will assure airlines that passengers will not take the law into their hands, especially after passengers' resistance to terrorists were acknowledged by the President of the United States. The invention applications will manage and direct a passengers force in the right manner, and most importantly, the invention applications consider the new doctrine that “No flight is a low risk flight,” and will provide security in the air, on all flights in an economical feasible solution. Furthermore, in democracies, people are used to provide security, to an extent where some constitutions gave citizens the right to make citizen's arrests, unlike other forms of governments where security is imposed on people. The invention applications will assure enhanced security measures with customer satisfaction, because passengers are able to provide security in a managed manner, along with government and airlines security.

In some embodiments, the mass transit security system of the invention coordinates the efforts of a Passenger Security Force, government security forces (including air marshals), mass transit security forces, and a ground control operation room.

Any formal security measure in mass transit centers may become a routine after some period of time. Terrorists strike when they observe routines in any form of resistance. Passenger reaction to an emergency situation, however, is unpredictable. Thus, passenger resistance (which would depend on different passengers' reactions) would not become routine. For example, on board one mass transit vehicle, a PSF member may contact a ground control center to notify them of what is happening on board the vehicle and wait for guidance on how to proceed. While on board another mass transit vehicle, a PSF member may coordinate an immediate attack on the terrorists.

It is obvious to conclude that any security system, which does not take passengers' resistance into consideration, is an incomplete system. When passengers stop terrorists, they give security agencies great leads (e.g., suspects) to pursue, in the war against terrorism.

Need to Organize Passenger Resistance

Passenger resistance to terrorism has been proven effective, for example, on Sep. 11, 2001 on board United Airlines flight 93 and on Dec. 23, 2001 on board American Airlines flight 63. An added motivation to organizing passenger resistance is the fact that the U.S. Air Force may be authorized to shoot down civilian planes if they are hijacked and are approaching civilian targets (e.g., buildings or train stations).

On the other hand, passenger resistance, when it is not coordinated, could create a threat to the safety of mass transit vehicles and other passengers. For example, the actions of passengers may interfere with the actions of a U.S. Air Marshall. Thus, it is even more important for governments and mass transit authorities to acknowledge that an organized Passenger Security Force is vital.

Organization of a Passenger Security Force is as important as the organization of, for example, mass transit security forces. When passenger resistance is not organized, it may lead to injury to other passengers on board the mass transit vehicle. These other passengers may hold the operator of the mass transit vehicle (e.g., an airline) responsible (e.g., via a lawsuit) for their injuries. Thus, to avoid the financial burdens of costly lawsuits based on injuries caused by fellow passengers who are acting without the special training provided by the mass transit security system described herein, it is important for mass transit authorities to support a Passenger Security Force.

The New Security Sector

Since Sep. 11, 2001, numerous security measures have been put into place in the two existing sectors of deterrence against terrorism:

1. Airlines security (AS).

2. Government's Security (GS).

Most of these security measures were known before Sep. 11, 2001, but were not implemented due to, for example, high operating cost, customer inconvenience, and lack of initiative by, for example, mass transit authorities. Some of these security measures included enforcing cabin doors and hiring additional security personnel to screen baggage.

The events of Sep. 11, 2001 illustrated that any security system that does not take passenger resistance into consideration is an incomplete security system.

Passenger Security Force (PSF) is a new security sector that enhances and completes the two existing security sectors, forming the following mathematical equation:

Complete Security Deterrence against terrorism=(AS)+(GS)+(PS)

Where, (AS) is Airlines security, (GS) is Government security, and (PR) is passengers' security.

Passenger Security Force

A Passenger Security Force (PSF) team will contribute to resisting any terrorist attacks in emergency situations in conjunction with, for example, mass transit security forces and government security forces.

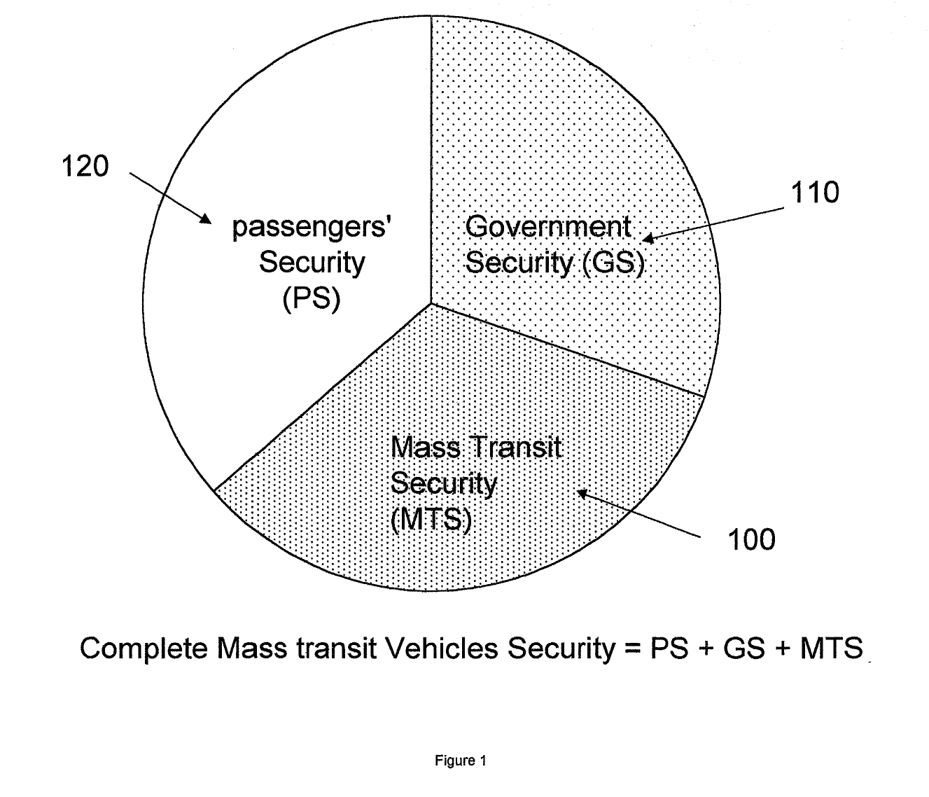

FIG. 1 illustrates a block diagram of airline security that is divided into three sectors, after introducing the passenger security sector, in accordance with some embodiments of the invention. The three sectors include a mass transit sector 100, a government sector 110, and a passengers sector 120. In some embodiments, all three sectors are equally important. For example, in FIG. 1, each sector is depicted as being approximately equal, but in other embodiments, each sector may have various significance.

Creating a Passenger Security Force

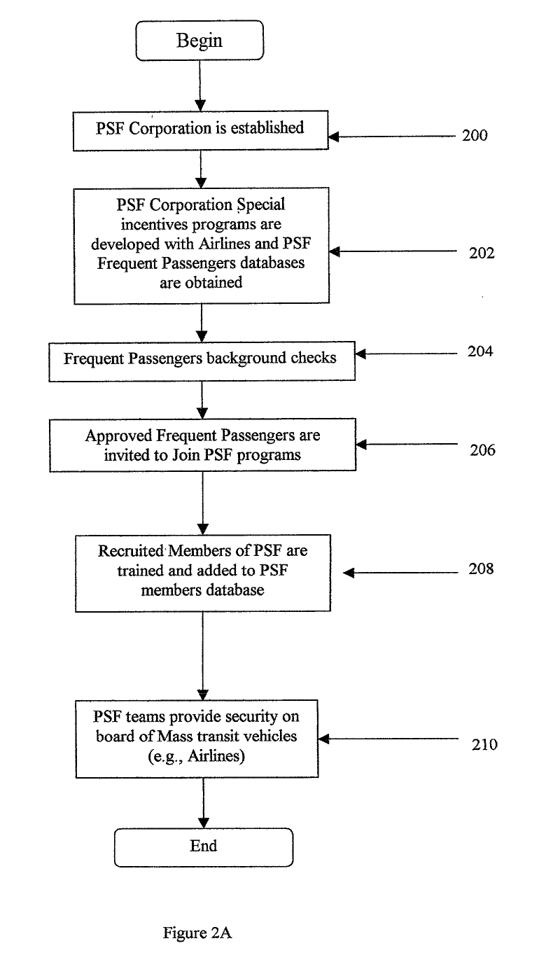

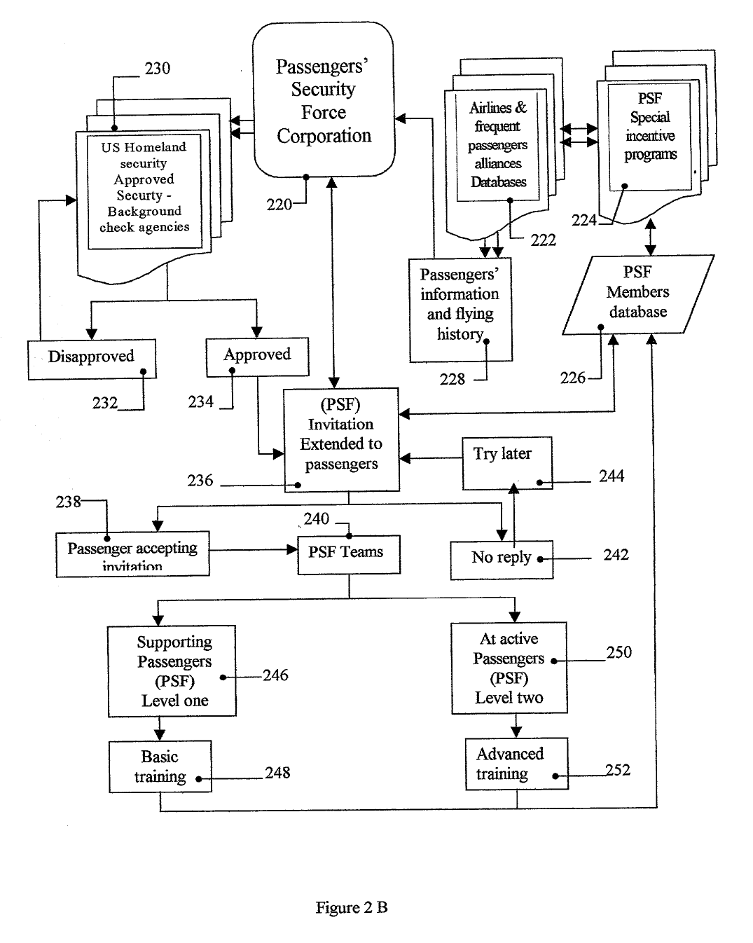

A Passenger Security Force is created, and PSF members are grouped into PSF teams. In some embodiments, creating a Passenger Security Force may be achieved by establishing an entity (e.g., a PSF entity), such as a corporation (e.g., a Passenger Security Force corporation), as shown in FIGS. 2A-2B. The PSF entity would identify and invite particular individuals (e.g., from frequent passenger programs) to be in the Passenger Security Force. Additionally, the PSF entity would train the selected individuals to coordinate their reactions to an emergency situation. In some embodiments, the selected individuals will become members of PSF teams while they are traveling. In some embodiments, the individuals have to specify that they would like to act in the capacity of a PSF member when making travel arrangements, otherwise, the individuals would not obtain the benefits of PSF membership (e.g., boarding the vehicle before other passengers).

In some embodiments, the Passenger Security Force (PSF) may be managed by a PSF entity based in the United States of America and having offices worldwide. For example, independent teams of specialists in various fields, including consumers' rights advocates, security advisors, database and software technicians, skilled corporate negotiators, airlines, airports and mass transit specialists, attorneys at law, health care professionals, journalists, media experts, and skilled management teams may manage the Passenger Security Force.

In negotiating with mass transit companies, the PSF entity may request special benefits for PSF members when traveling on board mass transit vehicles, such as extra frequent flyers points (e.g., miles) for a frequent passenger program, guaranteed reservations, and guaranteed discounts on travel fares. In some embodiments, PSF members may not be compensated with cash amounts for their participation in the program, except the negotiated benefits and rewards programs that may be designed for PSF members. In other embodiments, PSF members maybe compensated instead of or in addition to the negotiated benefits. In yet other embodiments, the PSF members may be volunteers.

In some embodiments, a limit on the number of PSF members traveling on a mass transit vehicle may be implemented (e.g., only 3-7 PSF members may travel in their capacity as PSF members, on any one airplane) and/or there may be a limit on how many trips a PSF member may benefit from (e.g., a PSF member may travel with the benefits of PSF membership 5 trips per year). This is to allow a maximum number of PSF members to enjoy the benefits of PSF membership. In some embodiments, within a period of time (e.g., ten years), most approved frequent passengers may be part of the Passenger Security Force.

The PSF entity may raise a one-time initial investment to be determined by a feasibility study, and then charge mass transit authorities (e.g., airlines) a small management fee (e.g., per hour/flight).

In some embodiments, within a period of time (e.g., five years) of implementing a Passenger Security Force, PSF members may be on board all national and international mass transit vehicles. In some embodiments, within a period of time (e.g., 10 years), most approved frequent passengers may be part of the Passenger Security Force. The involvement of many individual frequent passengers in the Passenger Security Force is expected to lead to a security minded culture, while also improving mass transit security.

In some embodiments, the PSF entity organizes passenger resistance to terrorist attacks by creating a culture of security-minded passengers, thus ensuring optimal security and safety on board mass transit. The PSF entity recruits and trains frequent passengers in order to be able to have one or more PSF members on almost every commercial civilian flight, worldwide. Thus, the mass transit security system assists in developing a security-minded culture, and mass transit becomes safer.

The success of the Passenger Security Force may be based on a number of factors, such as the following:

Government acknowledgment of the importance of the Passenger Security Force and involvement in organizing the Passenger Security Force.

The hiring of a highly qualified management team to run the PSF Corporation

Development of effective marketing campaigns to recruit frequent passengers.

Development of effective training programs by top professionals in the security field to ensure positive results during an emergency situation in which a PSF team coordinates their reactions.

Obtaining appropriate benefit and incentive programs for volunteer PSF members with mass transit operators (e.g., airlines and their alliances).

PSF Operation

In some embodiments, a PSF entity may be the engine behind recruiting, training, implementing and advertising for the Passenger Security Force in flights and other mass transit systems around the world.

In some embodiments, a PSF entity may invite selected frequent passengers (e.g., frequent passenger members of one or more airlines) participating in any frequent passenger programs, around the world, to participate in the Passenger Security Force in return for additional frequent passenger benefits that could be negotiated with, for example, airlines or other mass transit systems, manufacturers, governments, and insurance companies.

Participants may be selected based on multiple factors, such as physical conditions (e.g., passing a health check up from one or more selected physicians) or age range (e.g., between the ages of 21 and 60). Invitation to join the Passenger Security Force may be extended after comprehensive background checks by approved governmental authorities (e.g., in the United States or other countries).

PSF members may participate in a basic training course and may receive follow-up monthly circular news and information letters issued by a PSF entity. In some embodiments, two levels of training may be implemented. For example, Level Two training may include training PSF members to provide support services to the remaining PSF members (e.g., by informing other PSF members of suspicious activity), and Level One training may include training PSF members to perform active duties (e.g., PSF members may physically apprehend a person involved in suspicious activity). In some embodiments, advanced courses in mass transit transportation security systems may also be available for Level One PSF members.

In some embodiments, PSF members may volunteer to board mass transit vehicles (e.g., airplanes), and may not be required or requested to board mass transit as a PSF member. In some embodiments, PSF members may be asked to be part of the Passenger Security Force based on their regular travel (e.g., flying) schedules. In some embodiments, PSF members may agree to modify their regular travel schedules under some circumstances so that they may travel as a PSF member (e.g., following the same rules airlines apply when they are overbooked for a flight), but at their discretion, PSF members may decline to modify their regular travel schedules. For example, if a first flight has a complete PSF team and a second flight needs one more PSF member to complete its PSF team, then a PSF member scheduled to fly on the first flight may switch to the second flight. Then, while traveling, PSF members can assist with security measures, gain extra frequent passenger points, and have a chance to defend themselves and/or other passengers in an emergency situation.

In some embodiments, government or other non-PSF security forces may allow the PSF entities to have some period of time (e.g., 1 to 5 minutes or a few hours for overseas flights) to attempt to control an emergency situation (e.g., stop hijackers) aboard a mass transit vehicle prior to intervening (e.g., shooting down an airplane that is headed towards a building).

FIGS. 2A and 2B illustrate flowcharts of acts demonstrating a process of how a Passenger Security Force may be created, in accordance with some embodiments of the invention. In block 200 of FIG. 2A, a PSF corporation is established. In block 202, PSF special incentive programs 224 (FIG. 2B) are developed. The PSF special incentive programs 224 may include discounts or additional frequent traveler points for frequent passengers.

In block 204, security background checks of frequent passengers are performed. For example, frequent passenger information 228 (e.g., names, ages, addresses, and traveling history) may be obtained by mass transit companies (e.g., airlines) and frequent passenger alliance databases (e.g., databases that are formed by multiple mass transit companies that work together, such as multiple airlines) 222. The PSF Corporation 220 may forward the frequent passenger information to security agencies 230, such as security agencies approved by the U.S. Homeland Security. In some embodiments, the Passenger Security Force may only request security background checks to frequent passengers who are 21-60 years old. The security agencies 230 perform thorough background checks on the frequent passengers.

If frequent passengers are not approved by security agencies (block 232), their names are returned to the security agencies for further investigation, or PSF may receive from security agencies only approved frequent passengers. In block 206, if frequent passengers are approved by security agencies 230, they are invited to join a Passenger Security Force (block 236). In some embodiments, invitations to join the Passenger Security Force are extended to frequent passengers who are 21-60 years old. In some embodiments, the passengers who are invited are not necessarily frequent passengers. In some embodiments, a mass marketing campaign is used to recruit passengers to be PSF members.

In block 208, the frequent passengers are added to a PSF member database 226, after training. The PSF member database 226 may be a unified worldwide general PSF member database for security approved frequent passengers.

If the frequent passenger accepts the invitation (block 238), the frequent passenger is added to a PSF team (block 240). If the frequent passenger rejects the invitation or does not respond (block 242), another invitation may be sent to the frequent passenger at a later time (block 244).

Once frequent passengers become PSF members, they are provided with training to coordinate their reactions to an emergency situation. For example, in some embodiments, the PSF members are organized into two types of training groups, a supportive (or Level Two) group or an active (or Level One) group. Passengers assigned to a Level Two group (block 246) receive basic training and information (block 248). The basic training and information may include video and audio tapes and booklets, prepared by security specialist detailing what is expected out of theses passengers during both peace and crises times, excluding any expectations of physical acts. This is in addition to reviewing the monthly PSF newspaper and other PSF circulars that will keep informing members of PSF teams of any development in this field.

Passengers assigned to a Level One group (block 250) receive advanced training and information (block 252). The advanced training and information may include video and audio tapes and booklets prepare by security specialist detailing what is expected out of theses passengers in both peace and crises times. This is in addition to reviewing the monthly PSF newspaper and other PSF circulars that will keep informing members of PSF teams of any development in this field, including the colored alert system created by Home land security office, if approved. At this level also, a home written exam could be required from members to make sure that members fully understand the information provided by PSF, before they actually perform PSF members' duties while they are traveling. It is important to note that training, in some embodiments, may not cover any actual physical training, as the goal in recruitments of passengers in both levels one and two, is to create a culture of informed and security-aware passengers, that is wide spread and cover all civilian flights.

A PSF member database may continue to evolve and may be available to interact with pre-agreed special incentive frequent passenger programs with the different mass transit companies (e.g., airlines and alliances).

In some embodiments, a PSF member team will be a non-armed civilian passenger force that would assist and help the crew (e.g., flight crew on board an airplane) of a mass transit vehicle in an emergency situation (e.g., an incidence of terrorism). They may, for example, operate under the command of the captain of a flight (or other leader for other mass transit vehicles), board the vehicle before other passengers, be introduced to the vehicle's crew and to each other, report special identification (e.g., badge numbers) to the mass transit company, and sit in pre-assigned seats according to existing security contingency plans. The PSF members would keep their status as PSF members confidential and act according to their training.

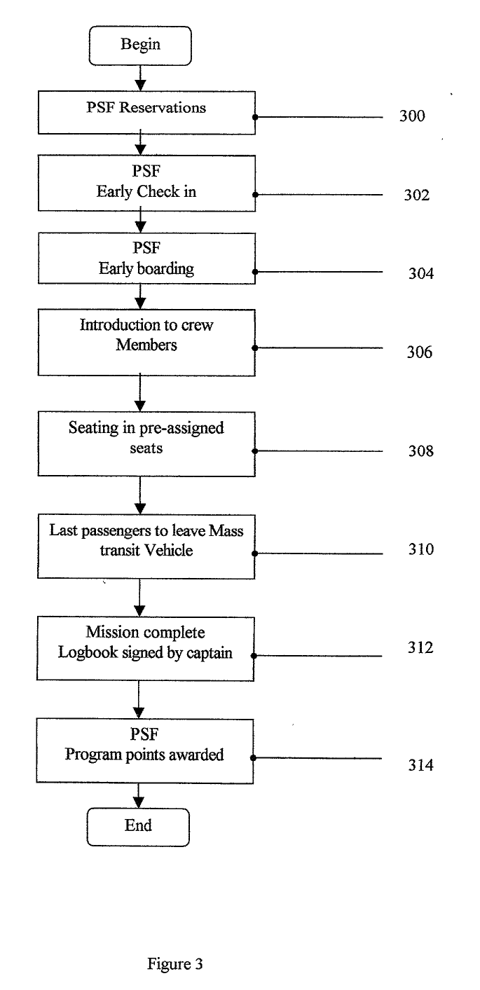

FIG. 3 illustrates, in a flowchart, acts demonstrating what is expected of PSF members from the time they reserve a seat on a mass transit vehicle, until they earn program points, in on-going flights, in accordance with some embodiments of the invention. In some embodiments, PSF members may make reservations through the PSF entity, and in some embodiments, PSF members may make reservations directly through a mass transit reservation system (e.g., an PSF reservation system) (block 300). The PSF member has early check-in (block 302) and early boarding (block 304). The PSF member is introduced to crew members (block 306). The PSF member sits in a pre-assigned seat (block 308). The PSF member is typically one of the last passengers to leave the mass transit vehicle (block 310), at which time the captain or other crew member signs a mission complete logbook indicating that the PSF member completed a mission (block 312). Then, the PSF member is awarded PSF program points (block 314). In other embodiments, one or more of these acts in FIG. 3 may be skipped or replaced with other acts.

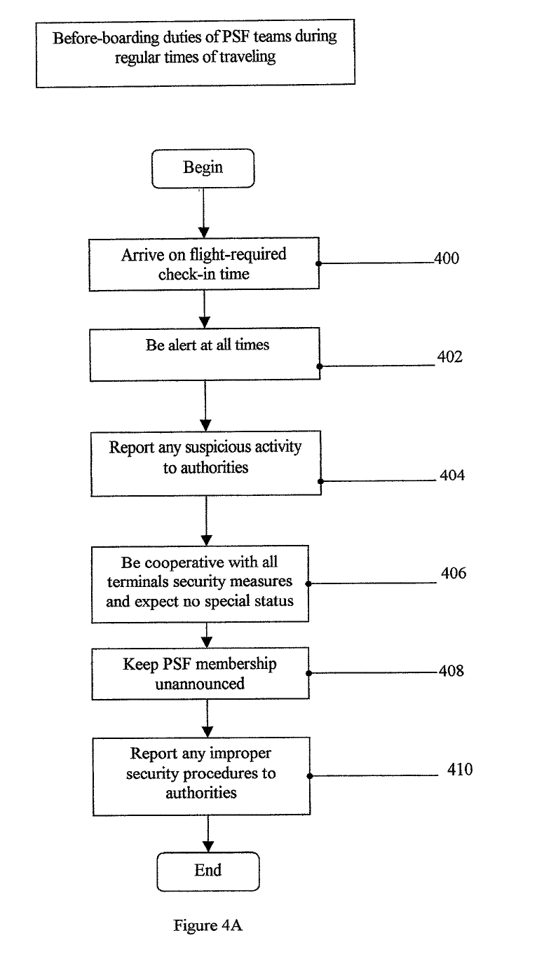

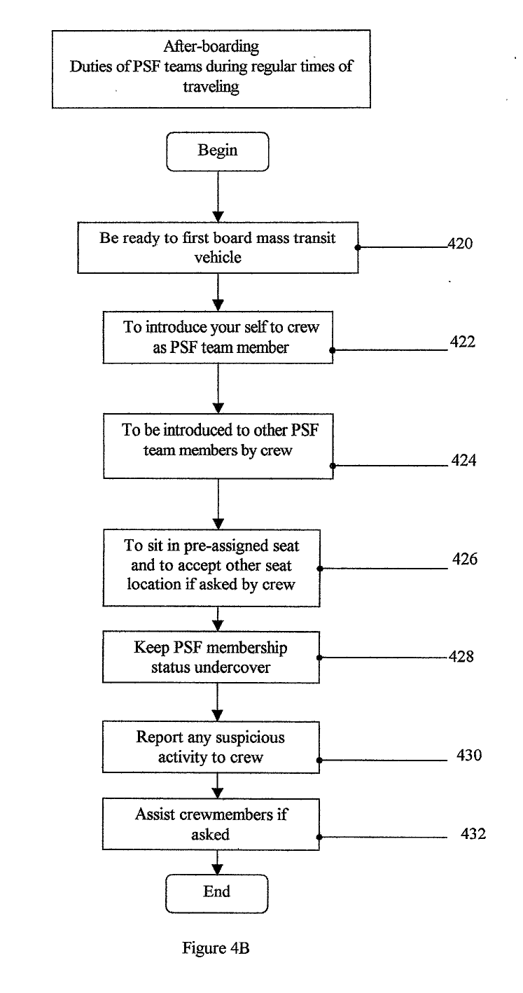

FIGS. 4A and 4B illustrate flowcharts of acts demonstrating what is expected of PSF members during non-emergency situations and emergency situations, respectively, while traveling, in accordance with some embodiments of the invention. Before boarding a mass transit vehicle (block 400), the PSF member should be observant of other people and activities at all times (block 402) and should report any suspicious activity to mass transit authorities (block 404), expect no special treatment by terminal security personals (block 406), keep PSF membership unannounced (block 408), and report any improper security procedures to authorities (e.g., luggage screening machines are not operational) (block 410).

After boarding a mass transport vehicle, a PSF member should introduce himself to crew as PSF team member (block 422), to be introduced to other PSF team members (block 424), to sit in pre-assigned seat and/or to accept other seat location if asked by crew (block 426), to keep PSF membership from other passengers (block 428), be observant of other people and activities at all times and should report any suspicious activity to the vehicle's crew (block 430). The PSF member may also need to assist crewmembers upon request (block 432).

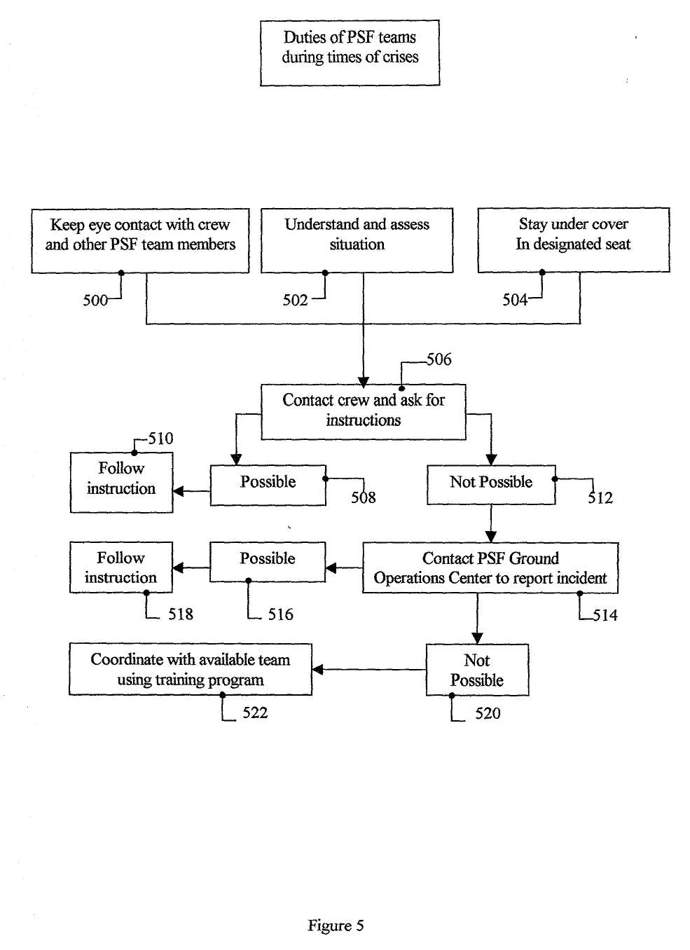

FIG. 5 illustrates a flowchart of acts demonstrating what is expected of PSF members in emergency situations during travel, in accordance with some embodiments of the invention.

The PSF member should keep eye contact with crew and other PSF members (block 500), assess the situation (block 502), and stay under cover (block 504). A PSF member may assess whether it is possible to report any suspicious move, activity, and/or conversation to the crew and ask for instructions (block 506). If it is possible (block 508), the PSF member contacts the crew and follows their instructions (block 510). If it is not possible to contact the crew (block 512), the PSF member may assess the possibility of contacting a ground control operation room (e.g., ground headquarters) (block 514) during the travel period (e.g., during a flight), using, for example, airline available commercial communication systems. If it is possible to contact the ground control operation room (block 516), the PSF member follows instructions from the ground control operation room (block 518). If it is not possible (block 520), the PSF member coordinates with other available PSF members in accordance with the PSF program training (block 522).

The Passenger Security Force may also contribute to and enhance Air Marshals programs implemented by the U.S. government. The PSF members may coordinate efforts with an Air Marshall or other federal authority on board the mass transport vehicle.

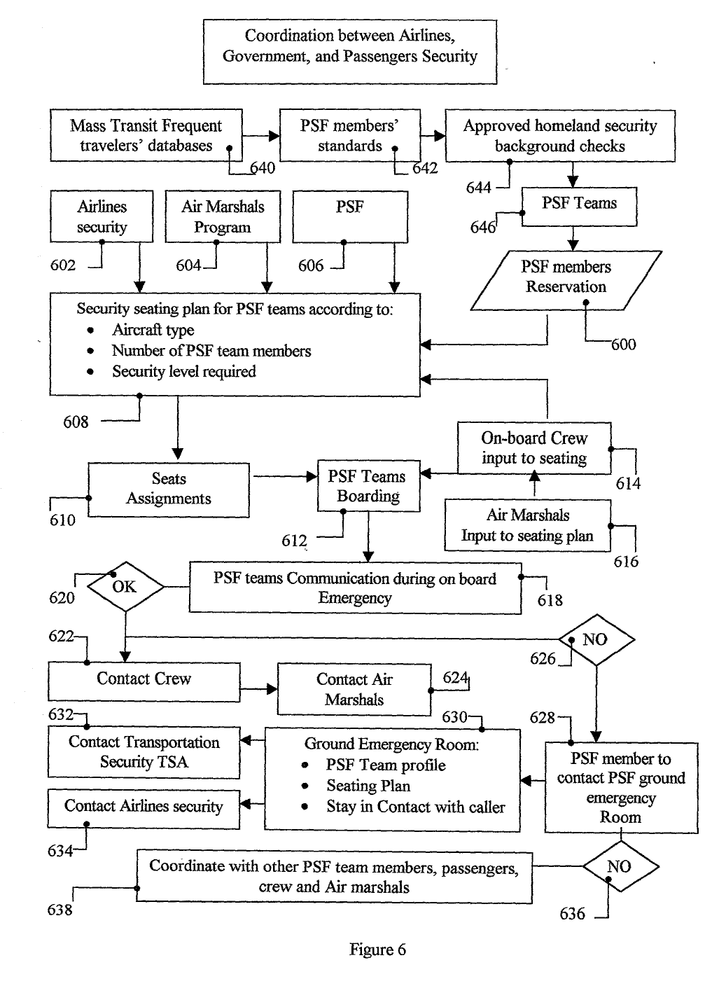

FIG. 6 illustrates a flowchart of acts demonstrating coordination between the three security sectors: mass transit sector, government sector, and passengers sector, in accordance with some embodiments of the invention. A PSF reservation database (block 600) will be available for mass transit (e.g., airline) security (block 602) before every flight to assign seats (block 604) to PSF members. Mass transit security may coordinate seat assignments with the Air Marshals program (block 608). A PSF ground emergency operation room (block 630) may be established and ready to take any calls (block 628) from PSF members on board of any flight, providing information on PSF members on board, location, and communications, to other security sectors (e.g. government and airlines security). This may take place in coordination with Airline security and Civil Aviation security (block 608).

On board the hijacked United Airlines flight 93 that crashed in rural Pennsylvania on Sep. 11, 2001, passengers called their families. PSF members may be provided with a special emergency number to call to inform the ground emergency operation room of any problems. In some embodiments, the PSF members may decide on whether to attempt to gain back control of the hijacked airplane. In any case, the PSF members would be trained to handle emergency situations and would have a better chance to win the battle, save their lives, and give security agencies a great lead to pursue.

Passengers, who feel assured that one or more PSF members are on board a mass transit vehicle, will feel safer on board and have a better experience traveling, while a terrorist would be faced with a complete system of deterrence.

Corporate Management Structure

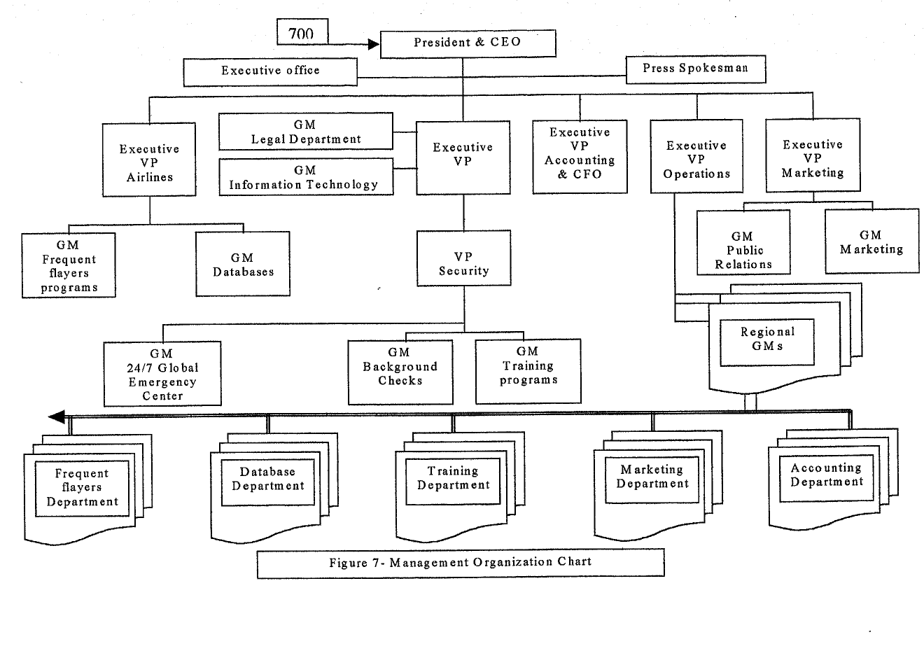

FIG. 7 illustrates a block diagram of a corporate management structure 700 for a PSF corporation, in accordance with some embodiments of the invention. A PSF corporation may employee, for example 270 employees, including officers of the PSF Corporation. The officers may include experienced executives who are recruited to fill the following positions:

President and/or Chief Executive Officer (CEO)

Executive Vice President

Chief Financial Officer (CFO), Executive Vice President Accounting

Executive Vice President of Marketing

Executive Vice President of Operations

Executive Vice President of Mass Transit

Executive Office General Manager

Press Spokesperson

A President and/or Chief Executive Officer (CEO) may oversee 269 employees of the corporation, including five Executive Vice Presidents and an Executive Office General Manager.

An Executive Vice President oversees 54 employees who form the core of the PSF Corporation's legal, information technology, and security departments (referred to herein as “Executive Vice President” branch). The Executive Vice President branch may be considered highly classified and only individuals who undergo a security screening will be allowed within this branch. The Executive Vice President oversees a Vice President of Security and eight General Managers, including Legal, Information Technology, Background Screening, Training, and 24/7 Global Emergency Center.

A Chief Financial Officer (CFO), Executive Vice President Accounting oversees ten employees at the PSF Corporation and oversees financial departments within each branch of the PSF Corporation.

An Executive Vice President of Marketing oversees 62 employees including three General Managers of Marketing, Public Relations, and of a PSF Monthly Magazine.

An Executive Vice President of Operations oversees 96 employees of six regional offices, each of which has a Regional General Manager. Each Regional General Manager is responsible for five heads of departments for Accounting, Marketing, Training, Database, and Frequent Passenger Programs.

An Executive Vice President of Mass Transit for each type of mass transit may exist. For purposes of illustration, an Executive Vice President of Airlines is illustrated in FIG. 7. The Executive Vice President of Airlines oversees two General Managers of Databases and Frequent Passenger Programs.

An Executive Office General Manager oversees 15 employees and is responsible for clerical services of the CEO, and employees' affaires.

A Press Spokesperson heads a press office and oversees 3 press professionals.

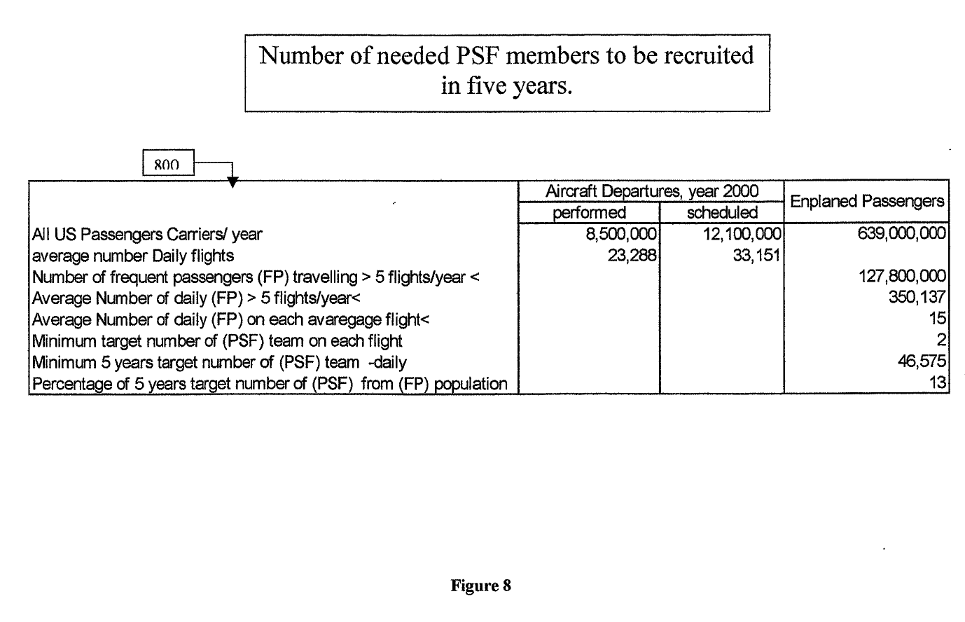

In some embodiments of the invention, there may be a management fee per PSF member. The PSF Corporation may hire 270 employees and raises US $80 million. The PSF Corporation is expected to break even by charging mass transit carriers (e.g., airlines) an average of US $30.00 per average flight per PSF member and by successfully recruiting 2% of frequent passengers who travel an average of 5 flights per year. After achieving a target of recruiting 13% of frequent passengers who travel an average of 5 flights per year, the charge by the PSF Corporation for management fees to mass transit carriers (e.g., airlines) may be reduced to US $12.00 per average flight per PSF member, with a minimum of two PSF members being on a PSF team on board of each national and international flight. FIG. 8 illustrates a table 800 of the target minimum PSF members to be recruited in 5 years in accordance with some embodiments of the invention.

Although the invention has been described with reference to particular embodiments, the description is only an example of the invention's application and should not be taken as a limitation. The order in which the steps of the present technique are performed is purely illustrative in nature. In fact, the blocks in the flow diagrams described herein may be performed in any order or in parallel, unless otherwise indicated by the present disclosure.

While particular embodiments of the present invention have been shown and described, it will be apparent to those skilled in the art that changes and modifications may be made without departing from this invention in its broader aspect, and, therefore, the appended claims are to encompass within their scope all such changes and modifications as fall within the true spirit of this invention.

[image]

[image]

[image]

I claim:

1. A method of organizing a passenger security force for mass transit vehicles, the passenger security force operating when a vehicle is away from a terminal.

2. The method of claim 1, wherein the passenger security force along with airline security (AS) and government security (GS) provides a security deterrence against terrorism in airplanes.

3. A method, comprising:
creating a passenger security force program;
inviting frequent passengers to join a passenger security force;
training members of the passenger security force to coordinate their reactions to an emergency situation on a mass transit vehicle; and
coordinating efforts of a ground control operation room, a government security force, a mass transit security force, and the passenger security force during an emergency on the mass transit vehicle.

4. The method of claim 3, wherein the mass transit vehicle is an airplane.

5. The method of claim 3, further comprising:
screening via a security background check frequent passengers through a security agency.

6. The method of claim 3, wherein the frequent passengers are selected based on multiple criteria.

7. The method of claim 6, wherein the criteria includes physical condition.

8. The method of claim 3, wherein the passenger security force program comprises two levels of training.

9. The method of claim 8, wherein the first level of training is directed to active duties.

10. The method of claim 8, wherein the second level of training is directed to support services.

11. The method of claim 3, further comprising:
developing incentive programs to reward frequent passengers for participating in the passenger security force program.

12. A method for improving mass transit security, comprising:
identifying frequent passengers;
screening frequent passengers through a security agency;
inviting frequent passengers who are approved by the security agency to join a passenger security force team; and
providing training to passenger security force team members to enable the team members to coordinate their efforts during an emergency situation.

13. The method of claim 12, further comprising:
adding frequent passengers who are approved by the security agency to a passenger security force database.

14. The method of claim 12, further comprising:
providing training to the team members for non-emergency situations.

15. The method of claim 12, wherein the team members work in conjunction with government security forces.

16. The method of claim 12, wherein the team members work with a ground control operation room.

17. The method of claim 12, wherein the team members work with mass transit security forces.

18. A method for improved mass transit, comprising:
receiving an invitation to join a passenger security force program;
accepting the invitation;
receiving training at either a first or second level;
traveling as a passenger security force member on a mass transit vehicle; and assisting with emergency situations on board the mass transit vehicle.

19. The method of claim 18, further comprising:
observing surroundings; and
reporting suspicious individuals or activities to authorities.

20. The method of claim 18, further comprising:
contacting a ground control operation room to report suspicious individuals or activities to authorities.

21. The method of claim 18, further comprising:
coordinating reactions to the emergency situation with one or more passenger security force members on board the mass transit vehicle.

22. The method of claim 18, further comprising: receiving passenger security force benefits for traveling as a passenger security force member on a mass transit vehicle.
